(19) United States
(12) Patent Application Publication
(10) Pub. No.: US 2006/0255897 A1
(43) Pub. Date: Nov. 16, 2006

(54) Electronic component, and method for manufacturing the same

(76) Inventors: Hideki Tanaka, Higashiosaka-shi (JP); Tomoyuki Washizaki, Fukui-shi (JP); Kiyoshi Ikeuchi, Nishinomiya-shi (JP); Toshiyuki Iwao, Fukui-shi (JP); Yasuki Nagatomo, Sadowara-cho (JP); Kesato Iiboshi, Takanabe-cho (JP); Jiro Ota, Sadowara-cho (JP); Yasuhiro Izumi, Shintomi-cho (JP)

Correspondence Address: WENDEROTH, LIND & PONACK L.L.P., 2033 K. STREET, NW, SUITE 800, WASHINGTON, DC, 20006, US

(21) Appl. No.: 10/554,699

(22) PCT Filed: Apr. 30, 2004
(86) PCT No.: PCT/JP04/06276

§ 371 Date: Oct. 27, 2005

(30) Foreign Application Priority Data
May 8, 2003 (JP) 2003-130091

(51) Int. Cl. H01F 27/02

(52) U.S. Cl. 336/83

(57) ABSTRACT

An electronic component is provided in which: impact-absorbing layers are provided so as to cover at least the corner portions of both end portions of a base which is made of an insulating mixture of ceramic and glass; a conductive film is formed so as to cover the surface of these impact-absorbing layers and the surface of the base; the portions of this conductive film which cover the surfaces of the impact-absorbing layers are formed into electrodes; and a resistance-adjusting groove is provided in an other portion of the conductive film than the portions serving as the electrodes.

### TECHNICAL FIELD

The present invention relates to an electronic component which is used for various kinds of electronic equipment, and a manufacturing method for the same.

### BACKGROUND ART

A conventional electronic component of this type will be described with reference to FIGS. 4A and 4B. FIG. 4A is a perspective view of a circuit protective element which is an example of the conventional electronic component. FIG. 4B is a sectional view of the circuit protective element, seen along an A-A line in FIG. 4A.

As shown in FIGS. 4A and 4B, the circuit protective element is configured by: a base 1; a conductive film 2; a protective film 5; and a plating layer 7. The base 1 is shaped like a pillar, such as a column and a prism. It is made of any of ceramic, glass, and a mixture of ceramic and glass, which have an insulation characteristic. The conductive film 2 is made of copper, silver, nickel or the like. It is formed over the entire surface of the base 1. An electrode 6 is formed by each of the portions of the conductive film 2 which are located at both end portions of the base 1. A plating layer 7 is formed on the surface of the electrode 6. The protective film 5 is made of epoxy resin or the like. It is formed so as to cover the portion of the conductive film 2's surface except its portions located at both end portions of the base 1.

A portion of the conductive film 2 is cut off by means of laser irradiation or the like. Thereby, a resistance-adjusting groove 3 is created in the conductive film 2. It makes substantially one turn so that its tips overlap each other. The region between the portions in which the tip portions of the resistance-adjusting groove 3 overlap each other is a narrow portion 4. As an electronic component which has such a groove, for example, there is a chip component which is disclosed in Japanese Patent Laid-Open No. 7-307201 specification.

Herein, the conductive film 2 is a portion which fulfills the electrical function of the circuit protective element. For example, if an electronic component is a resistor, it becomes a resistant body. In the case of the circuit protective element shown in FIGS. 4A and 4B, it turns into a fusing portion with a fusing function. In this case, if an over-current beyond a certain level is applied, the narrow portion 4 provided in the conductive film 2 generates heat. Thereby, it is melted and fused. This breaks the current which is applied on the circuit protective element.

Next, a manufacturing method will be described for the above described circuit protective element. First, over the whole surface of the base 1, the conductive film 2 is formed by means of plating. In this case, the electrode 6 is formed by the conductive film 2 located at both end portions of the base 1.

Sequentially, the conductive film 2 is irradiated with a laser beam to cut off a portion of the conductive film 2. Thereby, the resistance-adjusting groove 3 is formed which has substantially one turn so that its tips overlap each other. At this time, the narrow portion 4 is formed within the region between the overlapped portions in the tip portions of the resistance-adjusting groove 3.

Next, the protective film 5 made of epoxy resin or the like is formed to cover the surface of the conductive film 2 other than the portions located at both end portions of the base 1. Finally, the plating layer 7 is formed on the surface of the electrode 6.

In the circuit protective element which is manufactured in this way, a resistance value is measured in its manufacturing process, or the resistance-adjusting groove 3 is formed. In order to take such a measurement, the circuit protective element needs to be held. A chuck is pressed against the electrode 6 so as to come into contact with it. Thereby, the circuit protective element can be held.

At this time, if the contact resistance between the chuck and the electrode 6 becomes greater, the contact resistance at this portion may adversely affect the measurement of a resistance value. This makes it impossible to adjust the resistance value precisely. Therefore, the contact resistance between the chuck and the electrode 6 has to be made as low as possible. In order to reduce the contact resistance between the chuck and the electrode 6, the chuck needs to be pressed on the electrode 6 by a strong force.

On the other hand, in the above described circuit protective element, the conductive film 2 is formed on the entire surface of the base 1. Thereby, the conductive film 2 is united with the electrode 6 which is located at both end portions of the base 1. In this case, the conductive film 2 and the electrode 6 are continuously formed, thus helping stabilize their electrical and mechanical connection.

However, if the conductive film 2 and the electrode 6 are continuously united, then depending upon the circuit protective element's resistance value, the conductive film 2 becomes thinner and the electrode 6 also thins down. At this time, in order to lower the contact resistance between the chuck and the electrode 6, the chuck is pressed against the electrode 6 by a strong force. Then, the base 1 cannot absorb all the mechanical impact at the time when it is pressed, and thus, the corner portions at both end portions of the base 1 may be chipped. This is because the base 1 is made of any of ceramic, glass, and a mixture of ceramic and glass. If the circuit protective element which has such a chip in its corner portions is mounted on a printed board or the like, its stable electrical connection cannot be obtained. Hence, the circuit protective element with any chips in the corner portions has to be removed, thus deteriorating its yield when manufactured.

### DISCLOSURE OF THE INVENTION

It is an object of the present invention to provide an electronic component and its manufacturing method in which even if a chuck is pressed against an electrode located on both end-portion sides of a base by a strong force for the purpose of holding the electronic component, then the corner portions at both end portions of the base can be prevented from being chipped, and thus, its yield rate can be improved.

An electronic component according to an aspect of the present invention electronic component includes: an insulating base; an impact-absorbing layer which is formed so as to cover at least the corner portions of both end portions of the base; and a conductive film which is formed so as to cover at least a portion of the surface of the base and the surface of the impact-absorbing layer.

In the above described electronic component, even if a mechanical impact is given to both end portions of the base when the electronic component is held, this mechanical impact can be absorbed into the impact-absorbing layer. Therefore, in order to hold the electronic component, even if a chuck is pressed, by a strong force, on an electrode located on both end-portion sides of the base, then the corner portions at both end portions of the base can be hindered from being chipped. This helps enhance its yield.

An electronic-component manufacturing method according to another aspect of the present invention includes: a first process of forming an impact-absorbing layer so as to cover at least the corner portions of both end portions of an insulating base; and a second process of forming a conductive film so as to cover at least a portion of the surface of the base and the surface of the impact-absorbing layer.

In the above described electronic-component manufacturing method, an impact-absorbing layer is formed so as to cover at least the corner portions of both end portions of an insulating base. Thereafter, a conductive film is formed so as to cover at least a portion of the surface of the base and the surface of the impact-absorbing layer. Therefore, the impact-absorbing layer can be formed between both end portions of the base and the conductive film. As a result, even if a mechanical impact is given to both end portions of the base when the electronic component is held, this mechanical impact can be absorbed into the impact-absorbing layer. Therefore, in order to hold the electronic component, even if a chuck is pressed, by a strong force, on an electrode located on both end-portion sides of the base, then the corner portions at both end portions of the base can be hindered from being chipped. This helps enhance its yield. Besides, the impact-absorbing layer is formed before the conductive film is formed. Therefore, when the impact-absorbing layer is formed, the conductive film which is an element assembly of the electronic component can be kept from being damaged. This prevents the characteristics of an electric component from being deteriorated.

### BRIEF DESCRIPTION OF THE DRAWINGS

FIG. 1A is a perspective view of a circuit protective element according to an embodiment of the present invention. FIG. 1B is a sectional view of the circuit protective element, seen along an A-A line in FIG. 1A.

FIGS. 2A to 2F are perspective and sectional views of the circuit protective element shown in FIGS. 1A and 1B, showing its manufacturing method and processes.

FIGS. 3A to 3F are perspective and sectional views of the circuit protective element shown in FIGS. 1A and 1B, showing its manufacturing method and processes.

FIG. 4A is a perspective view of a circuit protective element which is an example of a conventional electronic component. FIG. 4B is a sectional view of the circuit protective element, seen along an A-A line in FIG. 4A.

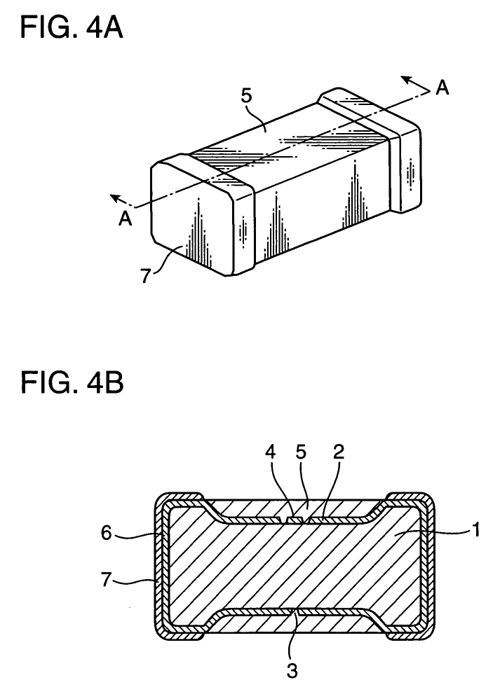

### BEST MODE FOR IMPLEMENTING THE INVENTION

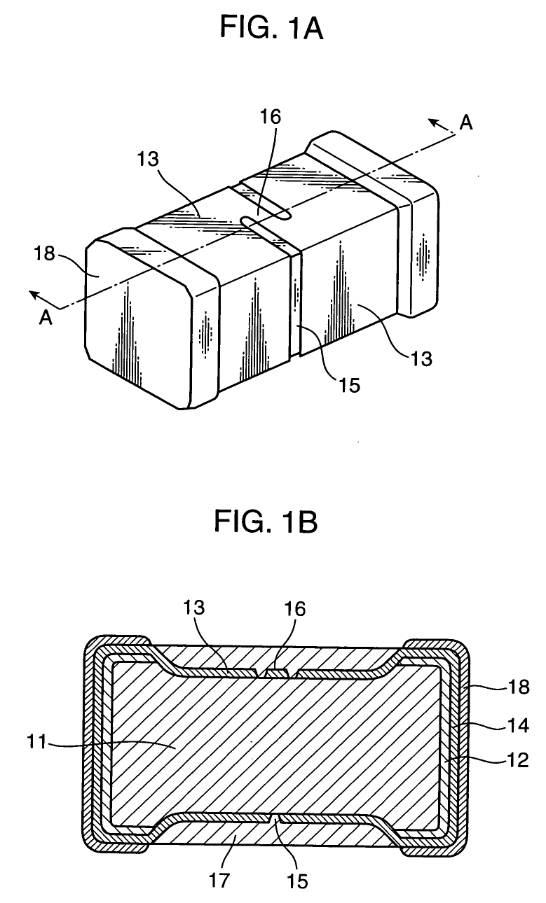

Hereinafter, a circuit protective element according to an embodiment of the present invention will be described with reference to the drawings. FIG. 1A is a perspective view of the circuit protective element according to the embodiment of the present invention. FIG. 1B is a sectional view of the circuit protective element, seen along an A-A line in FIG. 1A. Herein, a circuit protective element will be described below as an example of the electronic component. However, the electronic component to which the present invention is applied is not limited especially to this example. Hence, it can be similarly applied to various chip components or the like.

The circuit protective element shown in FIGS. 1A and 1B is configured by: a base 11; an impact-absorbing layer 12; a conductive film 13; a protective film 17; and a plating layer 18. The base 11 is made of an insulating mixture of ceramic and glass. It is shaped like a prism, and its section at both ends is thicker than that in the center as if it were an iron dumbbell.

The impact-absorbing layer 12 is made of copper which is a ductile metallic material. It is formed by means of electro-less plating with copper, on the entire surface of both end portions of the base 11, or on both end surfaces of the base 11 and on side surfaces which extend out from both end surfaces. Herein, ductility means an object's property of the object itself stretching without being destroyed.

In order to configure the conductive film 13, a metallic film is formed by a sputtering method using titanium and copper. Then, it is plated with nickel, copper and gold in order. This multi-layer film covers the base 11 and the whole surface of the impact-absorbing layer 12. In the conductive film 13, the portion which covers the surface of the impact-absorbing layer 12 is used as an electrode 14.

The portion of the conductive film 13 other than the portions located on both end-portion sides of the base 11, for example, a portion of its middle portion, is helically cut off using a trimming method such as laser irradiation. Thereby, a resistance-adjusting groove 15 is formed which has substantially one turn so that its tips overlap each other at a predetermined interval. At this time, a narrow portion 16 is formed in the region between the portions in which the tip portions of the resistance-adjusting groove 15 overlap each other. In the narrow portion 16, a fusing portion is formed which functions as a fuse. Thereby, if an over-current beyond a certain level is applied on the circuit protective element, the narrow portion 16 provided in the conductive film 13 generates heat. Then, it is melted and fused, thus breaking the current which is given to the circuit protective element.

The protective film 17 is made of epoxy resin or the like. It is formed to cover the entire surface of the middle portion of the conductive film 13. Thereby, it protects the portion except the conductive film 13 located on both end-portion sides of the base 11. The plating layer 18 is made of a nickel plating layer and a tin plating layer. It is formed so as to cover the portion of the conductive film 13 which covers the surface of the impact-absorbing layer 12, or the surface of the electrode 14. Herein, in FIG. 1A, the protective film 17 is omitted so that the resistance-adjusting groove 15 and the narrow portion 16 can be clearly shown.

As described above, in this embodiment, the impact-absorbing layer 12 is provided so as to cover at least the corner portions of both end portions of the base 11 which is made of a brittle material which is an insulating mixture of ceramic and glass. Then, the conductive film 13 is formed so as to cover the impact-absorbing layer 12 and the surface of the base 11. In the conductive film 13, the portion which covers the surface of the impact-absorbing layer 12 is used as the electrode 14.

Therefore, when a resistance value is measured, or when the resistance-adjusting groove 15 is formed, in order to hold the circuit protective element, even if a chuck is pressed, by a strong force, against the electrode 14 located on both end-portion sides of the base 11, then the impact-absorbing layer 12 provided between both end portions of the base 11 and the electrode 14 can absorb a mechanical impact at the time when it is pressed. Thereby, the corner portions of both end portions of the base 11 can be hindered from being chipped, thus improving its yield rate.

In addition, copper which is a ductile metallic material is used as the impact-absorbing layer 12. Therefore, the above described mechanical impact can be certainly absorbed. Besides, the protective film 17 is provided on the surface of the conductive film 13 so that it covers at least the resistance-adjusting groove 15. Thereby, the resistance-adjusting groove 15 can also be certainly protected.

Furthermore, the plating layer 18 made of a nickel plating layer and a tin plating layer is formed on the surface of the conductive film 13 located on both end-portion sides of the base 11. Therefore, the surface mounting of the circuit protective element can be conducted, thus making smaller and thinner a circuit or the like which the circuit protective element is mounted.

Herein, the three-dimensional shape of the base 11 is not limited especially to the above described example. Another shape but a prism, for example, a columnar shape, a sheet-like shape or the like may also be used. Moreover, without changing its section's thickness at both ends from that in the center, the base 11 whose section has the same thickness from one of its ends up to the other may also be used. In addition, the sectional shape of the base 11 is not limited especially to the above described example. Various shapes can also be used, such as a regular polygon, a circle, a rectangle and an ellipse. Furthermore, the material of the base 11 is not limited especially to the above described example, either. A single insulating material such as ceramic and glass may also be used. The present invention can be suitably used for various insulating brittle materials.

Herein, the method of forming the impact-absorbing layer 12 is not limited especially to the above described example, either. Various formation methods, such as another plating method, a sputtering method and a printing method, can also be used. Furthermore, the material of the impact-absorbing layer 12 is not limited especially to the above described example, either. A ductile metallic material, such as gold, silver, platinum, nickel, chromium, palladium and an alloy of these, can also be used. Moreover, the portion of the base 11 in which the impact-absorbing layer 12 is formed is not limited especially to the above described example, either. The impact-absorbing layer 12 can be provided in another portion, as long as it coves at least the corner portions of both end portions of the base 11 which is easily chipped by a mechanical impact, or the portions (i.e., the edge portions of both end portions) where the end surfaces of the base 11 intersect the side surfaces which extend from the end surfaces.

The portion in which the conductive film 13 is formed is not limited especially to the above described example, either. There is no need to cover the portion except the electrode 14 located on both end-portion sides of the base 11, or the whole surface of the middle portion of the base 11. It may also be formed so as to cover only a portion of the surface of the middle portion of the base 11, or the portion where a current concentrated portion is formed which becomes a fusing portion that embodies a fusing function. In that case, it is continuously united with the electrode 14 located on both end-portion sides of the base 11. In addition, the material and formation method of the conductive film 13 are not limited especially to the above described example, either. Various conductive films can be used: only a metallic film is used which is formed by a sputtering method using titanium and copper; a multi-layer film is used which is formed by plating this metallic film with one or two that are chosen from among nickel, copper, gold, silver and the like; or a metallic film is used which is formed by plating this metallic film with one or more that are chosen from among nickel, copper, gold, silver and the like. A choice among these conductive films can be arbitrarily made according to what an electric component is used for. The usage purpose includes, for example: determining a resistance-value range; inhibiting the surface of the conductive film 13 from oxidizing; prompting the narrow portion 16 made of the conductive film 13 to be melted and fused; storing the heat which is generated at the narrow portion 16; and the like.

The shape of the resistance-adjusting groove 15 is not limited especially to the above described example, either. Various shapes can also be used, for example, a resistance-adjusting groove which is a little short of substantially one turn is formed in the conductive film 13, so that the tips of the groove face each other at an interval and do not overlap each other. Then, the region between the tip portions of the resistance-adjusting groove may also be used as a narrow portion which makes up a fusing portion. Furthermore, a resistance-adjusting groove can be formed in the conductive film 13, so that it makes several turns around the base 11. Thereby, it can also be as an electronic component such as an inductor and a resistor. Moreover, the method of forming the resistance-adjusting groove 15 is not limited especially to the above described example, either. A narrow portion which makes up a fusing portion may also be formed by forming a notch in the conductive film 13 by a mechanical cutting method using a trimming blade or the like.

In addition, the material of the protective film 17 is not limited especially to the above described example, either. Another resin may also be used, such as a phenol resin, a polyimide resin and a silicone resin. Besides, a denatured resin of each of these, also including an epoxy resin, may also be used. Furthermore, the position in which the protective film 17 is formed is not limited especially to the above described example, either. It does not necessarily cover the entire surface of the middle portion of the conductive film 13, as long as it covers at least the position where the resistance-adjusting groove 15 is formed.

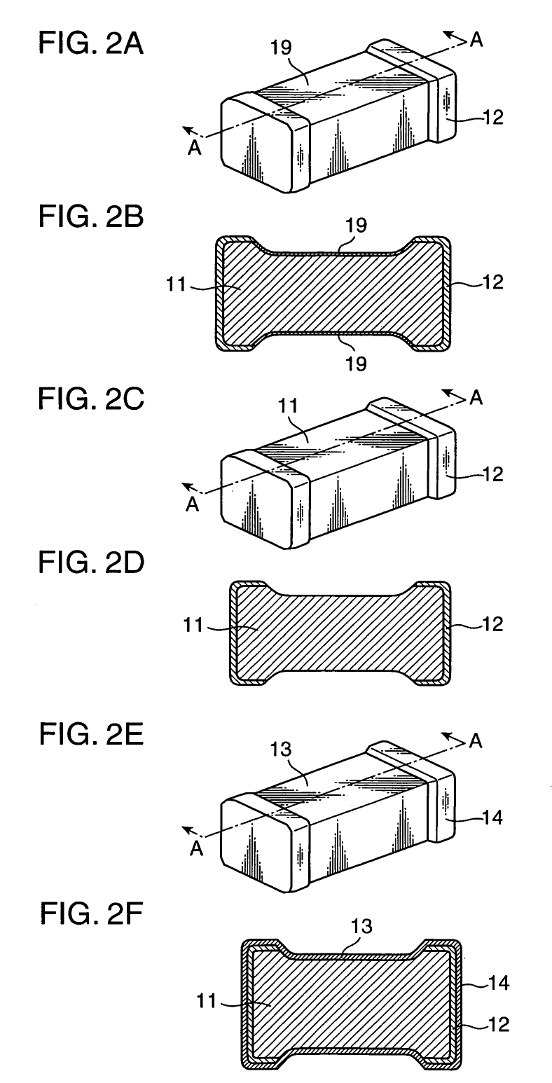

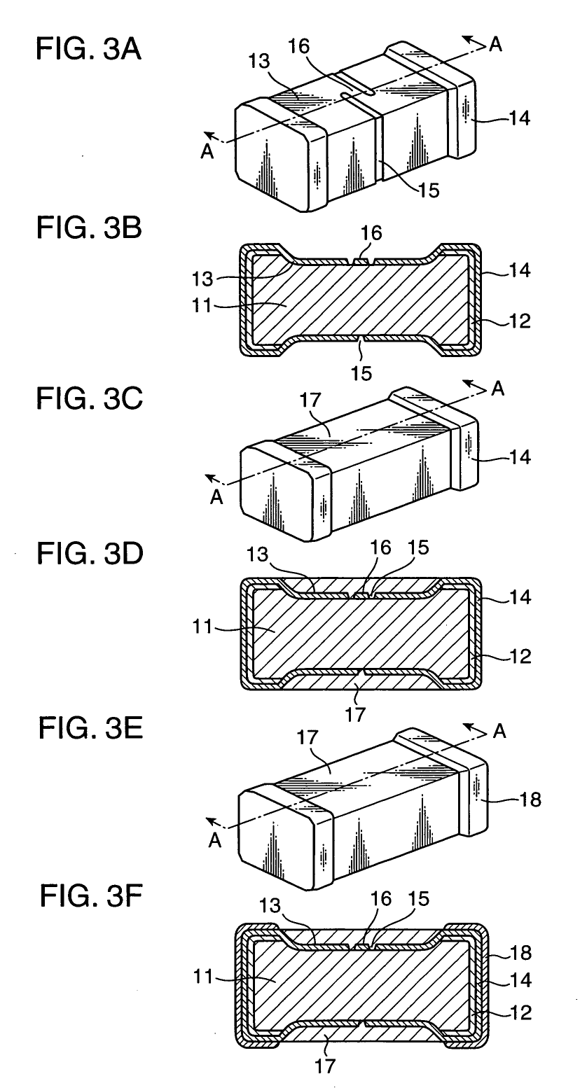

Next, the manufacturing method for the circuit protective element shown in FIGS. 1A and 1B will be described in further detail. FIGS. 2A to 2F and FIGS. 3A to 3F illustrate a manufacturing process for explaining the manufacturing method of the circuit protective element shown in FIGS. 1A and 1B. Herein, FIGS. 2A, 2C, 2E and FIGS. 3A, 3C, 3E are perspective views of the circuit protective element shown in FIGS. 1A and 1B in each manufacturing process. FIGS. 2B, 2D, 2F and FIGS. 3B, 3D, 3F are sectional views of the circuit protective element, seen along the A-A line in FIGS. 2A, 2C, 2E and FIGS. 3A, 3C, 3E.

First, with reference to FIGS. 2A and 2B, a resist film 19 is formed on the whole surface except both end portions of the base 11 which is made of an insulating mixture of ceramic and glass. Next, the impact-absorbing layer 12 made of copper is formed by electro-less plating, so that it covers the whole surface of both end portions of the base 11 other than the resist film 19. Herein, in the case where the impact-absorbing layer 12 or the conductive film 13 is formed by electro-less plating, preferably, in advance, the entire surface of the base 11 should be etched and undergo an activation treatment which has a catalytic action for electro-less plating.

Sequentially, as shown in FIGS. 2C and 2D, the resist film 19 is removed from the base 11. At this time, the resist film 19 and the portion of the impact-absorbing layer 12 which adheres to the resist film 19 are simultaneously removed. As a result, the impact-absorbing layer 12 remains only in both end portions of the base 11. Hence, in its portion other than this, the surface of the base 11 is exposed.

Next, as shown in FIGS. 2E and 2F, the conductive film 13 is formed so as to cover the entire surface of the portion of the base 11 which is exposed by removing the resist film 19 and the portion of the impact-absorbing layer 12 that adheres to the resist film 19 at the same time, as well as the whole surface of the impact-absorbing layer 12. As the conductive film 13, a metallic film is formed by a sputtering method using titanium and copper. Then, it is plated with nickel, copper and gold in order. At this time, in the conductive film 13, the portion which covers the surface of the impact-absorbing layer 12 is used as the electrode 14. Thereby, the conductive film 13 is united with the electrode 14 which is located at both end portions of the base 11. This makes the conductive film 13 and the electrode 14 continuous. In this case, the conductive film 13 and the electrode 14 are continuously formed, thus helping stabilize the electrical and mechanical connection of the conductive film 13 to the electrode 14.

Sequentially, as shown in FIGS. 3A and 3B, a portion of the conductive film 13 is cut off by means of laser irradiation. Thereby, the resistance-adjusting groove 15 is formed which makes substantially one turn so that its tips overlap each other. At this time, a narrow portion 16 is formed in the region between the portions in which the tip portions of the resistance-adjusting groove 15 overlap each other.

Next, as shown in FIGS. 3C and 3D, the protective film 17 which is made of epoxy resin or the like is formed so as to cover the portion of the conductive film 13's surface except its portions located at both end portions of the base 11. Lastly, as shown in FIGS. 3E and 3F, the plating layer 18 which is made of a nickel plating layer and a tin plating layer is formed on the surface of the electrode 14.

In the above described manufacturing method for the circuit protective element, the impact-absorbing layer 12 is formed so as to cover both end portions of the insulating base 11. Thereafter, the conductive film 13 is formed so as to cover the surfaces of the base 11 and the impact-absorbing layer 12. Therefore, the impact-absorbing layer 12 can be formed between both end portions of the base 11 and the electrode 14. Consequently, even if a mechanical impact is applied on both end portions of the base 11 when the circuit protective element is held, this mechanical impact can be absorbed into the impact-absorbing layer 12. Therefore, in order to hold the circuit protective element, even if a chuck is pressed, by a strong force, on the electrode 14 located on both end-portion sides of the base 11, then the corner portions at both end portions of the base 11 can be prevented from being chipped. This helps improve its yield rate.

In addition, the impact-absorbing layer 12 is formed before the conductive film 13 is formed. Therefore, when the impact-absorbing layer 12 is formed, the conductive film 13 which is an element assembly of an electronic component or the portion which fulfills the electrical function of the circuit protective element can be kept from being damaged. This prevents the characteristics of the circuit protective element from getting worse.

Furthermore, after the resist film 19 is formed on the whole surface other than both end portions of the base 11 which is made of an insulating mixture of ceramic and glass, the impact-absorbing layer 12 is formed so as to cover the entire surface of both end portions of the base 11. Thereafter, the resist film 19 is separated from the base 11. Therefore, the impact-absorbing layer 12 can be prevented from going out of the middle portion of the base 11, or the portion in which there is no need to provide the impact-absorbing layer 12. This makes it possible to form the impact-absorbing layer 12 precisely at the portion where it needs to be provided.

Herein, in the above described manufacturing method for the circuit protective element, the impact-absorbing layer 12 is formed only in both end portions of the insulating base 11 by an electro-less plating method. However, the impact-absorbing layer 12 may also be formed to cover on the whole surface of the resist film 19 by a sputtering method and the entire surface of both end portions of the base 11. In that case, if the resist film 19 is removed, the impact-absorbing layer 12 formed on the resist film 19 is also removed simultaneously. Therefore, in the same way as the case where the impact-absorbing layer 12 is selectively formed by means of electro-less plating, the impact-absorbing layer 12 can be formed only in both end portions of the insulating base 11.

### INDUSTRIAL APPLICABILITY

As described so far, according to the present invention, an impact-absorbing layer is provided so as to cover at least the corner portions of both end portions of a base which is made of any of ceramic, glass, and a mixture of ceramic and glass, which have an insulation characteristic. In addition, a conductive film is formed so as to cover the surface of this impact-absorbing layer and the surface of the base. In this conductive film, the portion which covers the surface of the impact-absorbing layer is used as an electrode. Therefore, when a resistance value is measured, or when a resistance-adjusting groove is formed, in order to hold an electronic component, even if a chuck is pressed, by a strong force, against the electrode located on both end-portion sides of the base, then the impact-absorbing layer between both end portions of the base and the electrode formed on both end-portion sides of the base by a portion of the conductive film can absorb its mechanical impact. Thereby, the corner portions of both end portions of the base can be prevented from being chipped, thus improving its yield rate.

1. An electronic component, characterized by including:
an insulating base;
an impact-absorbing layer which is formed so as to cover at least the corner portions of both end portions of the base; and
a conductive film which is formed so as to cover at least a portion of the surface of the base and the surface of the impact-absorbing layer.

2. The electronic component according to claim 1, characterized in that the base is made of one of ceramic, glass, and a mixture of ceramic and glass.

3. The electronic component according to claim 1, characterized in that the impact-absorbing layer is made of a ductile metallic material.

4. The electronic component according to claim 3, characterized in that the impact-absorbing layer is formed on both end surfaces of the base and on side surfaces which extend out from both end surfaces.

5. The electronic component according to claim 1, characterized in that the portion of the conductive film which covers the surface of the impact-absorbing layer is used as an electrode.

6. The electronic component according to claim 5, characterized by further including a resistance-adjusting groove which is formed in an other portion of the conductive film than the portion where the electrode is formed.

7. The electronic component according to claim 6, characterized in that a narrow portion which is formed between the tip portions of the resistance-adjusting groove is a fusing portion which serves as a fuse.

8. The electronic component according to claim 7, characterized in that the electronic component is a circuit protective element.

9. The electronic component according to claim 6, characterized by further including a protective film which is formed on the surface of the conductive film so as to cover at least the resistance-adjusting groove.

10. The electronic component according to claim 1, characterized by further including a plating layer which is formed in the portions of the conductive film that are located on the both-end sides of the base.

11. An electronic-component manufacturing method, characterized by including:
a first process of forming an impact-absorbing layer so as to cover at least the corner portions of both end portions of an insulating base; and
a second process of forming a conductive film so as to cover at least a portion of the surface of the base and the surface of the impact-absorbing layer.

12. The electronic-component manufacturing method according to claim 11, characterized in that:
the first process includes the steps of,
forming a resist film on the whole surface except both end portions of the base, and
forming the impact-absorbing layer so as to cover the whole surface of both end portions of the base; and
the second process includes the steps of,
removing the resist film from the base, and
forming the conductive film so as to cover at least a portion of the surface of the exposed portion of the base which is exposed after the resist film is removed and the surface of the impact-absorbing layer.

13. The electronic-component manufacturing method according to claim 11, characterized in that the first process includes the step of forming the impact-absorbing layer so as to cover at least the corner portions of both end portions of the base which is made of one of ceramic, glass, and a mixture of ceramic and glass.

14. The electronic-component manufacturing method according to claim 11, characterized in that the first process includes the step of forming an impact-absorbing layer which is made of a ductile metallic material so as to cover at least the corner portions of both end portions of the base.

15. The electronic-component manufacturing method according to claim 14, characterized in that the first process includes the step of forming the impact-absorbing layer on both end surfaces of the base and on side surfaces which extend out from both end surfaces.

16. The electronic-component manufacturing method according to claim I1, characterized in that the second process includes the step of forming the conductive film so that its portion which covers the surface of the impact-absorbing layer is used as an electrode.

17. The electronic-component manufacturing method according to claim 16, characterized by further including a third process of forming a resistance-adjusting groove in an other portion of the conductive film than the portion where the electrode is formed.

18. The electronic-component manufacturing method according to claim 17, characterized in that the third process includes the step of creating a fusing portion which serves as a fuse by forming a narrow portion between the tip portions of the resistance-adjusting groove.

19. The electronic-component manufacturing method according to claim 17, characterized by further including a fourth process of forming a protective film on the surface of the conductive film so as to cover at least the resistance-adjusting groove.

20. The electronic-component manufacturing method according to claim 19, characterized by further including a fifth process of forming a plating layer in the portions of the conductive film that are located on the both-end sides of the base.
